(19) United States
(12) Patent Application Publication
(10) Pub. No.: US 2018/0342837 A1
(43) Pub. Date: Nov. 29, 2018

(54) Plug Holder to Safeguard Applicances

(71) Applicant: T-Rad Enterprises LLC, Poughkeepsie, NY (US)

(72) Inventor: Timothy Long, Poughkeepsie, NY (US)

(21) Appl. No.: 15/989,351

(22) Filed: May 25, 2018

Related U.S. Application Data
(60) Provisional application No. 62/511,106, filed on May 25, 2017.

(51) Int. Cl. H01R 13/639; F16B 1/00

(52) U.S. Cl. CPC H01R 13/6395; F16B 2001/0028; F16B 1/00

(57) ABSTRACT

A method for holding a plug in or near a socket is described. A hook and loop strap is configured to be fastened to an outlet cover. The hook and loop strap is configured to be fastened around one of: a plug plugged into a socket surrounded by the outlet cover, so that the strap holds the plug in the socket; or a plug next to a socket surrounded by the outlet cover so that the strap holds the plug near the socket.

This application claims benefit of U.S. Provisional application Ser. No. 62/511,106, filed on May 25, 2017, and herein incorporated by reference in its entirety.

### TECHNICAL FIELD

The disclosure relates to appliance safety, and more particularly, to improving appliance safety by holding a plug in a socket.

### BACKGROUND

Many appliances have power cords that need to be plugged into an electrical outlet. The plug end that is plugged into the socket of an electrical outlet can be pulled out accidentally, thereby damaging the appliance or increasing the risk of a fire starting at or near the socket.

### SUMMARY

A principal object of the present disclosure is to provide a device for holding a plug in a socket so that it is not accidentally pulled out.

Another object of the present disclosure is to provide a device for holding a plug near a socket.

In accordance with the objects of the disclosure, a plug holding device is achieved. The device comprises a hook and loop strap configured to be fastened to an outlet cover wherein the hook and loop strap is configured to be wrapped around a plug plugged into a socket surrounded by the outlet cover, so that the strap holds the plug in the socket. Alternatively, the hook and loop strap is configured to be wrapped around a plug next to a socket surrounded by the outlet cover so that the strap holds the plug near the socket.

Also in accordance with the objects of the disclosure a method for holding a plug in or near a socket is achieved. A hook and loop strap is fastened to an outlet cover. The hook and loop strap is fastened around one of: a plug plugged into a socket surrounded by the outlet cover, so that the strap holds the plug in the socket; or a plug next to a socket surrounded by the outlet cover so that the strap holds the plug near the socket.

### BRIEF DESCRIPTION OF THE DRAWINGS

In the accompanying drawings forming a material part of this description, there is shown:

FIG. 1 illustrates the components of a preferred embodiment of the present disclosure.

FIG. 2 illustrates an installation of the preferred embodiment of the present disclosure.

FIG. 3A illustrates a first alternative configuration of the preferred embodiment of the present disclosure.

FIG. 3B illustrates a second alternative configuration of the preferred embodiment of the present disclosure.

FIGS. 4-5 illustrate use of the preferred embodiment of the present disclosure.

FIG. 6 illustrates a first alternative use of the preferred embodiment of the present disclosure.

FIG. 7 illustrates a second alternative use of the preferred embodiment of the present disclosure.

### DETAILED DESCRIPTION

The present disclosure describes a device to hold a plug in a socket, thus preventing the plug from being pulled out accidentally. This will prevent damage to an appliance attached to the plug or reduce the risk of a fire that may start at or near the socket if the plug is pulled out accidentally.

Referring now to the drawing figures, the plug holding device of the present disclosure will be described in detail. FIG. 1 illustrates the components of the plug holding device. At least a screw 20 and a strap 24 are necessary for the plug holding device. An optional washer 22 is also shown. The strap 24 includes a hook and loop fastener. One surface of the strap 24 has hook fasteners thereon and the opposite surface of the strap has loop fasteners thereon. Optionally, a flame-retardant chemical is applied to the strap.

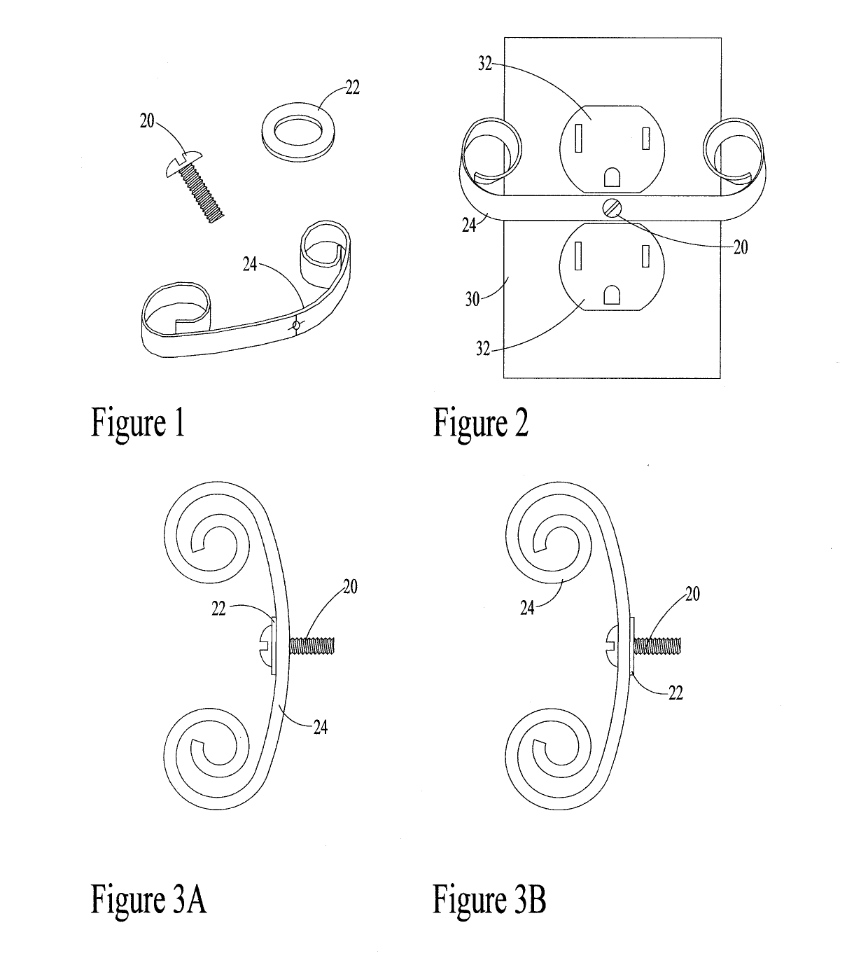

FIG. 2 illustrates a standard household electrical outlet cover plate 30, having two sockets 32, for example. The strap 24 will be attached to the outlet cover 30 using a screw 20. This is preferably the screw that holds the outlet cover to the outlet. FIGS. 3A and 3B show two alternative configurations of the attachment of the strap and the washer. As shown in FIG. 3A, the washer 22 may be placed on top of the strap 24. As shown in FIG. 3B, the washer 22 may be placed below the strap 24, between the strap and the outlet cover. Alternatively, the washer may be left out. If used, the washer reinforces the strap 24.

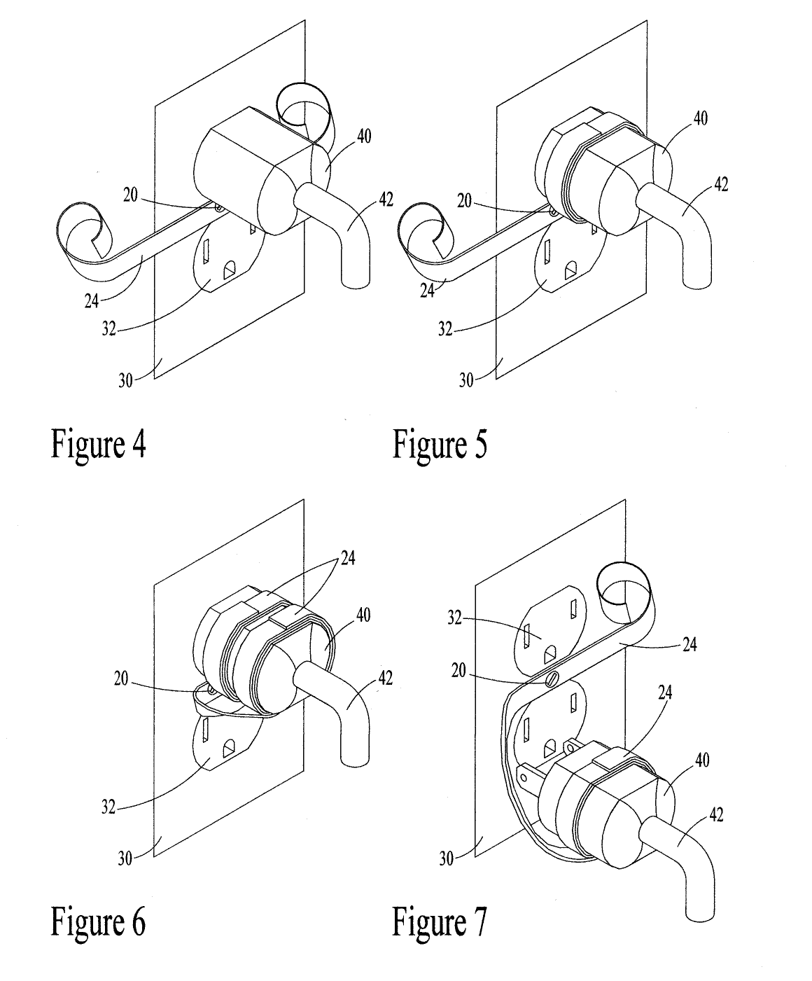

FIG. 4 illustrates a plug 40 at the end of a cord 42. The plug 40 is inserted into the socket 32. As shown in FIG. 5, one end of the strap 24 is wrapped around the plug 40 and fastened to itself to hold the plug in place. Optionally, the strap can be wrapped around the power cord 42 instead of or in addition to around the plug 40.

In order to provide even more security, the second end of the strap 24 may also be wrapped around the plug 40 and/or the cord 42 and fastened to itself, as shown in FIG. 6.

To assemble the plug holding device of the present disclosure, a user would remove the screw holding the outlet cover to the outlet. Then, the user would insert the screw 20 through a hole in the strap 24. If a washer 22 is to be used, the screw will be inserted first into the washer and then into the strap, or the screw will be inserted first into the strap and then into the washer. Finally, the screw will be inserted into the screw hole in the outlet cover and tightened. The fully assembled plug holder device is illustrated in FIG. 2.

To use the plug holder device, a user will insert a plug 40 into a socket 32, and then wrap one end of the strap 24 around the plug to hold it in place in the socket. The other end of the strap 24 can also be wrapped around the plug, as shown in FIG. 6, to provide added strength and protection. The device should be used for any plug that needs to be kept in the socket. The strap will prevent the plug from being accidentally pulled out of the socket.

In another use of the plug holding device of the present disclosure, a user could wrap the strap 24 around a plug 40 and/or cord 42 to keep the plug near the socket, as shown in FIG. 7. In this way, an appliance could be unplugged to prevent vampire electricity from leeching into the appliance when it is not in use. The strap will keep the plug next to the outlet so that it can be plugged in easily when desired. Since the plug is kept next to the outlet by the strap, the user will not have to search for the plug when it is time to plug it in.

Although the preferred embodiment of the present disclosure has been illustrated, and that form has been described in detail, it will be readily understood by those skilled in the art that various modifications may be made therein without departing from the spirit of the disclosure or from the scope of the appended claims.

What is claimed is:

1. A plug holding device comprising:
a hook and loop strap configured to be fastened to an outlet cover wherein said hook and loop strap is configured to be wrapped around a plug plugged into a socket surrounded by said outlet cover and fastened to itself, so that said strap holds said plug in said socket.

2. The device according to claim 1 wherein said hook and loop strap is configured to be fastened to said outlet cover by a screw through said hook and loop strap wherein said screw also fastens said outlet cover to an outlet.

3. The device according to claim 2 further comprising a washer configured to be located between said screw and said hook and loop strap or between said hook and loop strap and said outlet cover wherein said washer reinforces said hook and loop strap.

4. The device according to claim 1 wherein said hook and loop strap has a hook portion on an entire first surface and a loop portion on an entire opposite surface.

5. The device according to claim 1 wherein one end or both ends of said hook and loop strap are configured to be wrapped around said plug.

6. A plug holding device comprising:
a hook and loop strap configured to be fastened to an outlet cover wherein said hook and loop strap is configured to be wrapped around one of:
a plug plugged into a socket surrounded by said outlet cover, so that said strap holds said plug in said socket; or
a plug next to a socket surrounded by said outlet cover so that said strap holds said plug near said socket; and
wherein wrapped said hook and look strap is fastened to itself.

7. The device according to claim 6 wherein said hook and loop strap is configured to be fastened to said outlet cover by a screw through said hook and loop strap wherein said screw also fastens said outlet cover to an outlet.

8. The device according to claim 6 further comprising a washer configured to be located between said screw and said hook and loop strap or between said hook and loop strap and said outlet cover wherein said washer reinforces said hook and loop strap.

9. The device according to claim 6 wherein said hook and loop strap has a hook portion on an entire first surface and a loop portion on an entire opposite surface.

10. The device according to claim 6 wherein one end or both ends of said hook and loop strap are configured to be wrapped around said plug.

11. A method for holding a plug in or near a socket comprising:
fastening a hook and loop strap to an outlet cover; and
wrapping said hook and loop strap around one of:
a plug plugged into a socket surrounded by said outlet cover, wherein said strap holds said plug in said socket; or
a plug next to a socket surrounded by said outlet cover wherein said strap holds said plug near said socket; and
wherein wrapped said hook and look strap is fastened to itself.

12. The method according to claim 11 wherein said fastening said hook and loop strap to said outlet cover comprises:
inserting a screw through said hook and loop strap wherein said screw also fastens said outlet cover to an outlet.

13. The method according to claim 12 further comprising:
placing a washer between said screw and said hook and loop strap; or
placing a washer between said hook and loop strap and said outlet cover wherein said washer reinforces said hook and loop strap.

14. The method according to claim 11 wherein said hook and loop strap has a hook portion on an entire first surface and a loop portion on an entire opposite surface.

15. The method according to claim 11 wherein one end or both ends of said hook and loop strap are wrapped around said plug.
